(19) United States
(12) Patent Application Publication
(10) Pub. No.: US 2023/0406060 A1
(43) Pub. Date: Dec. 21, 2023

(54) Arrangement for a vehicle roof, and vehicle roof for a motor vehicle

(71) Applicant: Webasto SE, Stockdorf (DE)

(72) Inventor: Rudolf DIETL, Stockdorf (DE)

(21) Appl. No.: 18/196,602

(22) Filed: May 12, 2023

(30) Foreign Application Priority Data
May 25, 2022 (DE) 10 2022 113 272.2

(51) Int. Cl. B60H 1/00; F25B 21/02; F25B 27/00

(52) U.S. Cl. CPC B60H 1/00478; F25B 21/02; F25B 2321/023; B60H 2001/00235; F25B 27/002

(57) ABSTRACT

An arrangement for a vehicle roof, having a first pane element configured to realize an outer pane for the vehicle roof, a second pane element that is configured to realize an inner pane for the vehicle roof, the second pane element (2) being coupled to the first pane element, a cooling device, which may have a semiconductor layer having Peltier elements, and strip conductors connected to the semiconductor layer, and wherein the cooling device being designed to cool a vehicle interior, and being coupled to the second pane element, such that the cooling device is arranged between the first and the second pane element.

### CROSS-REFERENCE TO RELATED APPLICATION

This application claims priority from German Patent Application Number 10 2022 113 272.2, filed on May 25, 2022, which is hereby incorporated herein by reference in its entirety for all purposes.

### FIELD

The present disclosure relates to an arrangement for a vehicle roof that is designed to cool a vehicle interior, and in particular a vehicle roof, by means of a cooling device. The present disclosure also relates to a vehicle roof comprising such an arrangement.

### BACKGROUND

Some motor vehicles have a roof opening, integrated in the vehicle roof, that is closed by a cover, in particular made of glass, so as to realize a transparent view from the motor vehicle. If necessary, the cover is designed to be movable in order to allow not only a transparent view but also, if desired, an exchange of air.

It is desirable to create an arrangement for a vehicle roof that increases comfort in a vehicle interior.

### SUMMARY

According to one embodiment, an arrangement for a vehicle roof comprises a first pane element that is configured to realize an outer pane for the vehicle roof, and a second pane element that is configured to realize an inner pane for the vehicle roof and coupled to the first pane element. The arrangement further comprises a cooling device coupled to the second pane element such that the cooling device is arranged between the first and the second pane element. The cooling device comprises a semiconductor layer composed of Peltier elements.

A Peltier element has, for example, two or more small cuboids, each of p- and n-doped semiconductor material, which are alternately connected to each other at the top and bottom by metal bridges. The semiconductor material is, for example, a bismuth telluride and/or a silicon germanium. At the same time, the metal bridges form the thermal contact surfaces and are insulated by an overlying film or ceramic plate. In each case, two different cuboids are connected to each other in such a way that they form a series circuit. The supplied electric current flows through all the cuboids in succession. Depending on the intensity and direction of the current, the upper connection points cool down while the lower ones heat up. The current thus pumps heat up from one side to the other and creates a temperature difference between the plates.

This arrangement prevents the glass from heating up to more than 100° C. in direct sunlight, which might result in burns to the palms of the hands or to the head area of anyone touching it accidentally.

When the vehicle is parked outside, people will expect a hot surface because the interior will also heat up, for example the second window element. The situation is different when the vehicle is in operation. Since the interior is air-conditioned, people will not necessarily expect a hot surface. Such burns can be avoided by reducing the contact time, i.e. the period of time during which the skin is in contact with the hot surface. By lowering the surface temperature of the arrangement, the contact time before burns occur is increased, according to ISO13732. For this purpose, the surface temperature is cooled sufficiently by means of the cooling device of the arrangement.

The arrangement described makes it possible to realize a cover for a vehicle roof that provides a convenient cooling function and thus advantageously cools the cover sufficiently to prevent burns.

According to a further embodiment, the cover has an intermediate layer realized as a lamination film, which is arranged on an upper side of the cooling device, between the first pane element and the cooling device. The lamination film is coupled to the Peltier elements of the cooling device. According to further embodiments, a second lamination film may be provided, which is coupled to the first lamination film such that the Peltier elements are embedded between the first and the second lamination film.

According to further embodiments, the first and/or the second lamination film is/are realized as an electronically switchable layer element and provides/provide a convenient shading function. The one or more lamination films are made of or comprise, for example, polyvinyl butyral (PVB) and/or ethylene vinyl acetate (EVA) and/or thermoplastic polyolefin (TPO) and/or polyolefin (PO). As a switchable layer element, the one or more films are made of or comprise, for example, a suspended particle device (SPD) and/or a liquid crystal (LC) and/or polymer dispersed liquid crystals (PDLL).

If, for example, a switchable film is placed in the arrangement, this must also be placed such that the structure of the arrangement in relation to a stacking direction would be as follows: the outer pane is coupled to a first film that realizes a first lamination film. The semiconductor layer is coupled to the lamination film and is further coupled to a second film that forms a further lamination film. The Peltier elements are preferably embedded between the two lamination films. Further, a switchable film, which may be realized as a third lamination film, is coupled to the two lamination films. This is followed by a connection of the switchable film to the inner pane. Alternatively or additionally, there is preferably a further lamination film inserted between the switchable film and the glass of the inner pane. The lamination films serve in particular to effect the connection between the two pane elements. Thus, there may be various combinations of lamination films and/or switchable films placed in the arrangement.

According to a further embodiment, the arrangement comprises a solar cell layer, which is coupled to the first pane element and enables energy to be converted from light energy into electrical energy.

According to a further embodiment, the solar cell layer is divided into at least two mutually spaced and separate portions.

According to a further development, the solar cell layer comprises solar cells, for example in the form of plate-shaped, spherical and/or organic solar cells, and at least a first lamination film to which the solar cells are coupled. Further, a second lamination film may be provided, which is coupled to the first lamination film such that the solar cells are sandwiched between the first and second lamination film.

The arrangement described makes it possible to realize a cover for a vehicle roof that provides a convenient cooling function and that also enables light energy to be easily converted into electrical energy. Embodied as vehicle glazing, for example, the arrangement provides a combination of Peltier elements for convenient cooling of a vehicle interior and vehicle roof, and solar cells for energy conversion that can supply the cooling device with electric power. In combination with the solar cell layer, the cooling device has a clear and space-saving structure and is arranged, for example, on the side of the vehicle roof facing towards the vehicle interior and enables cooling of the vehicle interior. The cooling device makes it possible to realize efficient cooling of a vehicle interior and of a roof of a motor vehicle, which can help to increase the comfort of the motor vehicle.

For example, the one glass pane is provided and has an active solar cell layer vapour-deposited thereon such that the panes are joined to each other in a non-separable manner or in such a manner that they cannot be separated non-destructively.

The semiconductor layer and the solar cell layer comprise, for example, Peltier elements and solar cells, respectively, which are arranged in such a way that incident light that does not strike the Peltier elements or solar cells can enter the vehicle interior, thus providing transparency.

According to a further embodiment, the Peltier elements are arranged in the semiconductor layer in the form of mutually spaced individual islands. The islands in this case are distributed on notional straight lines and/or a structure, for example a network structure, within the semiconductor layer, which are substantially parallel and/or orthogonal to the longitudinal axes of the pane elements in the plane of the pane elements. An island comprises one Peltier element. The islands are electrically connected to each other by thin strip conductors, as is the case, for example, with conventional pane heating systems. In the case of such an island pattern, transparent regions alternate with opaque regions (islands), making it possible to achieve increased transparency of the vehicle roof with simultaneous cooling of the vehicle roof and/or of the vehicle interior.

According to a further embodiment, there are at least two mutually spaced and separate solar cell portions provided in the solar cell layer. These two solar cell portions are connected by means of a Peltier element in the semiconductor layer. The Peltier element comprises a p-doped and an n-doped semiconductor material, and in this case is realized and arranged in such a way that it connects one electrode of each of the solar cell portions. Thus, a connector of the Peltier element that is assigned to the p-doped semiconductor material is connected to an electrode of a first solar cell portion, and a connector of the Peltier element that is assigned to the n-doped semiconductor material is connected to an electrode of a second solar cell portion. Accordingly, these solar cell portions are interconnected either in series or in parallel by means of the Peltier element. Even though two solar cell portions are mentioned here, this number is to be regarded as an example. It is also possible to use more than two solar cell portions that are connected to one other, or interconnected, as described, by means of Peltier elements.

According to a further embodiment, there is a solar cell arranged on the Peltier element of an island. For example, the solar cell is integrated into the Peltier element such that the islands can also operate in an autonomously controlled manner, independently of the electrical system of the vehicle.

According to a further embodiment, the Peltier elements are arranged in the semiconductor layer in the form of strips, the strips being substantially parallel and/or orthogonal to the longitudinal axes of the pane elements, in the plane of the pane elements.

According to a further aspect, the Peltier elements may be arranged in a first region of the vehicle roof that has no solar cells.

According to a further aspect, the solar cells may be arranged in a second region of the vehicle roof that has no Peltier elements.

This special arrangement in one part of the glass surface provides thermoelectric protection against contact with the heads of the vehicle occupants.

Alternatively or additionally, the solar cells themselves may be transparent, such that light energy can be converted into electrical energy and, in addition, light can enter the vehicle interior. For example, flat solar cells are arranged in the solar cell layer, their upper sides having sensitive layers for the conversion of light energy into electrical energy. Alternatively or additionally, further surfaces of the solar cells may be sensitive for the absorption and conversion of light.

The solar cells may be laminated into composite glazing and, depending on their positioning, allow a partial transparent view through the arrangement, and be realized together with the cooling device in a vehicle glazing. Thus, the possibility of convenient cooling and environmentally friendly energy conversion are combined in one vehicle pane and costs, installation space and weight can be saved, as compared to separate implementation.

According to a further embodiment, the arrangement comprises a third pane element, which is configured to realize an intermediate pane for the vehicle roof. The second pane element is coupled to the first pane element, such that the interlayer, the semiconductor layer and/or the solar cell layer is/are arranged between the first and the second pane element. Thus, a composite pane can be realized, in which the intermediate layer, the semiconductor layer and/or the solar cell layer are arranged in a secure and protected manner.

The first pane element, as an outer pane, may realize the outermost element that is next to the exterior when installed in a vehicle roof of a motor vehicle. Alternatively, one or more elements may cover the first pane element from above, such that it does not realize the outermost element, but faces towards the exterior as compared to the second pane element or the cooling device. Accordingly, the second pane element, as an inner pane, may realize the innermost element that also delimits the vehicle interior when installed in a vehicle roof of a motor vehicle. Alternatively, one or more elements may cover the second pane element from below, such that it does not realize the innermost element, but faces towards the vehicle interior as compared to the first pane element.

The third pane element, as an intermediate pane, may realize the middle element that, when installed in a vehicle roof of a motor vehicle, separates the intermediate layer and/or the solar cell layer from the semiconductor layer. One or more elements may cover the third pane element from below or above, such that the third pane element faces towards the vehicle interior as compared to the first pane element.

The pane elements and/or the solar cell layer may be made of or comprise films, plastic and/or glass.

The arrangement described thus makes it possible, in particular, to achieve a cooling function for a vehicle interior and a vehicle roof, and to simultaneously realize efficient generation of electrical energy. It is thus possible to realize an advantageous combination of a cooling device in the glass roof and a solar roof, which has a positive effect on an environmental balance and a life cycle analysis, which can contribute to an increased comfort of the motor vehicle. Furthermore, an electrical heating of the glass composite can be effected by current reversal at the Peltier elements, which can thus have a de-icing function in winter.

According to a further aspect, a vehicle roof comprises a design of the arrangement described above and a cover that is coupled to the arrangement and designed to close an opening in the vehicle roof. The cover may be realized, for example, as a glass cover, with the arrangement forming a part or portion of the cover. Alternatively, the cover may be realized in its entirely by the arrangement.

According to one embodiment, the semiconductor layer is 0.1 mm to 1 mm, preferably 0.2 mm to 0.4 mm thick. This provides a particularly high efficiency of the Peltier element arranged in the semiconductor layer, i.e. good heat dissipation and, if necessary, heating.

The cover can be fixed in the opening in the vehicle roof or designed to be movable relative to the vehicle roof in order to release the roof opening when required. For example, the cover is a roof window that can be opened and closed, and that includes the cooling device and the solar cell layer.

### BRIEF DESCRIPTIONS OF THE DRAWINGS

Exemplary embodiments of the disclosure are explained in more detail below with reference to the schematic drawings.

In the drawings:

FIG. 1 shows an exemplary embodiment of a vehicle roof for a motor vehicle, in a perspective view,

FIG. 2 shows an exemplary embodiment of an arrangement for a vehicle roof according to FIG. 1,

FIG. 3 shows a further exemplary embodiment of an arrangement for a vehicle roof according to FIG. 1,

FIG. 4 shows a further exemplary embodiment of an arrangement for a vehicle roof according to FIG. 1,

FIG. 5 shows a further exemplary embodiment of an arrangement for a vehicle roof according to FIG. 1,

FIG. 6 shows a further exemplary embodiment of an arrangement for a vehicle roof according to FIG. 1,

FIG. 7 shows a further exemplary embodiment of an arrangement for a vehicle roof according to FIG. 1,

FIG. 8 shows an exemplary embodiment of a division of the Peltier elements in a plan view of the vehicle roof according to FIG. 1,

FIG. 9 shows a division of the Peltier elements in an island pattern, in schematic sectional views according to FIG. 8, according to exemplary embodiments,

FIG. 10 shows a further exemplary embodiment of a division of the Peltier elements in a plan view of the vehicle roof according to FIG. 1,

FIG. 11 shows a division of the Peltier elements in a strip pattern, in schematic sectional views according to FIG. 8, according to an exemplary embodiment, and

FIG. 12 shows a further exemplary embodiment of a division of the Peltier elements and of the solar cells in a plan view of the vehicle roof according to FIG. 1,

FIG. 13 shows a further exemplary embodiment of an arrangement for a vehicle roof according to FIG. 1,

FIG. 14 shows a further exemplary embodiment of an arrangement for a vehicle roof according to FIG. 1.

Elements of the same construction and function are denoted by the same reference designations for all figures.

### DETAILED DESCRIPTION

In this description, terms such as “top”, “bottom”, “upper side”, “underside”, “inside” and “outside”, “front” and “rear” relate to orientations and alignments as illustrated in the figures and customary for an operational motor vehicle.

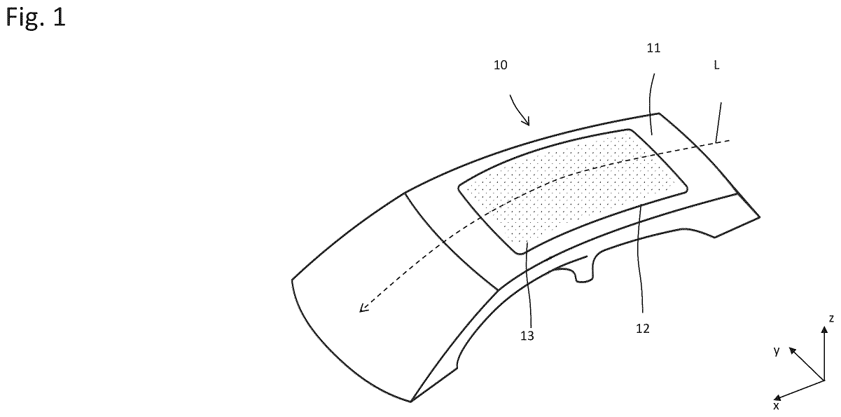

FIG. 1 shows an arrangement 10 for a vehicle roof 11, which for example realizes a cover 13 in the vehicle roof, which is designed to close a roof opening 12 in the vehicle roof 11. The arrangement 10 may form a part or portion of the cover 13 or alternatively realize it in its entirety. The arrangement 10 is designed, for example, as a glass cover. According to exemplary embodiments, the arrangement 10 comprises an outer pane 1, an inner pane 2, and a cooling device 6 that is arranged between the outer pane 1 and the inner pane 2. As explained with reference to FIGS. 1-10 and FIGS. 13 and 14, a convenient cooling device 6 is provided by means of the arrangement 10.

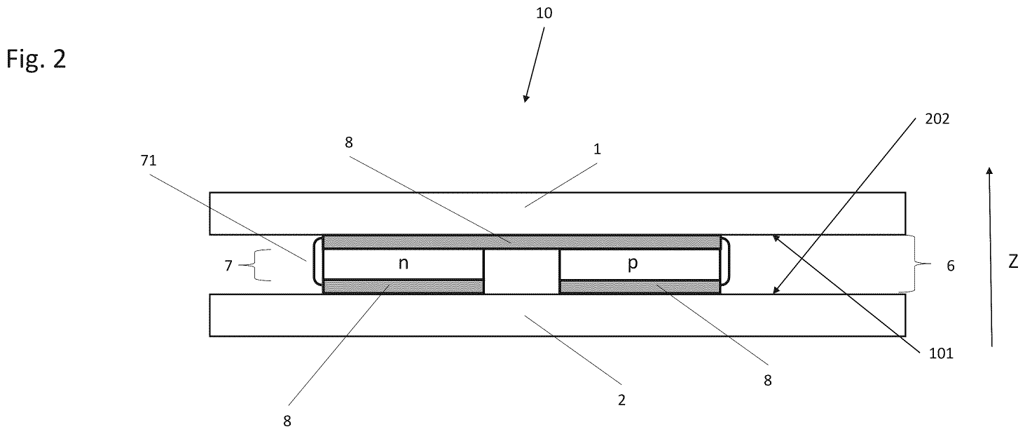

FIG. 2 shows an exemplary embodiment of the arrangement 10 in a schematic sectional view. The arrangement 10 has the outer pane 1 as a first pane element, and the inner pane 2 as a second pane element. The outer pane 1 has an underside 101 that faces towards the vehicle interior, and the inner pane 2 has an upper side 202 that faces away from the vehicle interior. The cooling device 6 is coupled to the underside 101 of the outer pane 1, such that the cooling device 6 is arranged, along the upward direction Z, between the underside 101 of the outer pane 1 and the upper side 202 of the inner pane 2. The cooling device 6 comprises a semiconductor layer 7 having a plurality of Peltier elements 71, for example 5, 10, 15, 20 or more Peltier elements 71, and strip conductors 8 connected to the semiconductor layer 7. By means of the strip conductors 8, the Peltier elements 71 can be supplied with energy and controlled, by closed-loop and/or open-loop control, via control electronics. For reasons of clarity, the cooling device 6 represented in FIG. 2 shows only one such Peltier element 71. Also for reasons of clarity, the size ratios of the individual components do not correspond to the true size ratios of the arrangement 10.

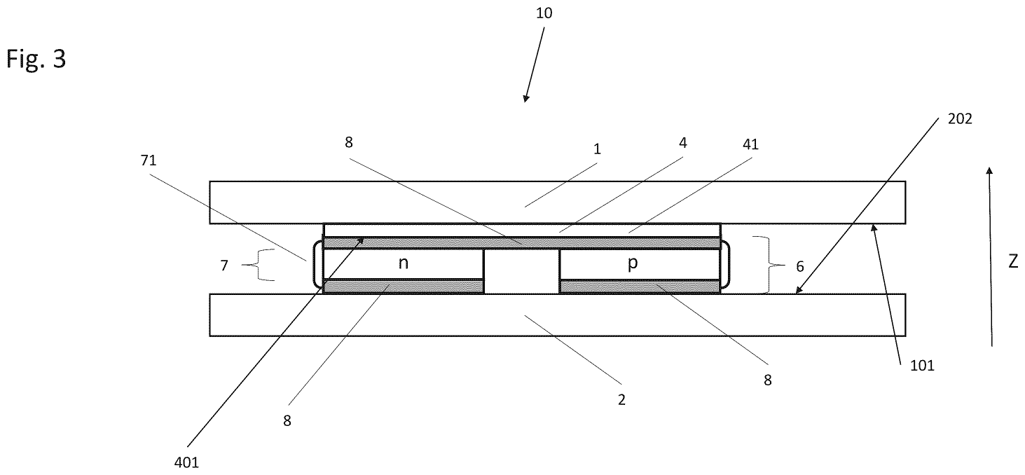

FIG. 3 shows an exemplary embodiment of the arrangement 10 in a schematic sectional view. The exemplary embodiment corresponds substantially to the exemplary embodiment according to FIG. 2. In addition, an intermediate layer 4 is provided. The intermediate layer 4 is realized as a lamination film 41 and is coupled to the underside 101 of the outer pane 1, such that the intermediate layer 4 is arranged between the underside 101 of the outer pane 1 and the cooling device 6. The cooling device 6 is coupled to an underside 401 of the intermediate layer 4, such that the cooling device 6 is arranged between the intermediate layer 4 and the upper side 202 of the inner pane 2.

The lamination film 41 is made, for example, of polyvinyl butyral (PVB), ethylene vinyl acetate (EVA), thermoplastic polyolefin (TPO) and/or polyolefin (PO). Moreover, the lamination film 41 may be configured as an electronically switchable film element. Preferably, in addition to the lamination film 41, one or more further lamination films are provided as electronically switchable film element, and are composed, for example, of a suspended particle device (SPD), of a liquid crystal (LC) and/or of polymer dispersed liquid crystals (PDLC). The switchable film element or elements provides/provide a convenient shading function for the vehicle interior.

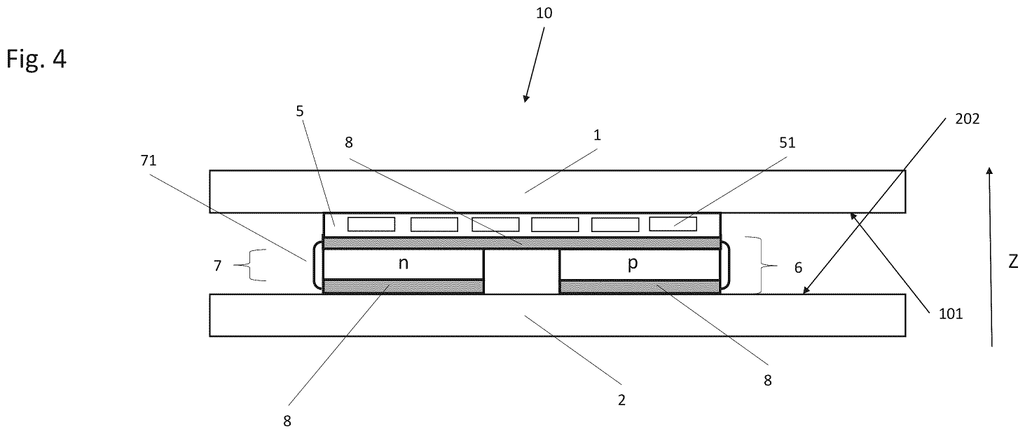

FIG. 4 shows an exemplary embodiment of the arrangement 10 in a schematic sectional view. The exemplary embodiment corresponds substantially to the embodiment according to FIG. 2. In addition, there is a solar cell layer 5 coupled to the underside 101 of the outer pane 1, such that the solar cell layer 5 is arranged between the underside 101 of the outer pane 1 and the cooling device 6. The solar cell layer 5 comprises in particular solar cells 51 in the form of wafers having crystalline structures, which can be realized relatively easily, inexpensively and with low effort with the arrangement 10, and which afford highly efficient energy conversion.

The arrangement 10 makes it possible to provide a convenient cooling device 6, and it makes possible and also provides a simple way of converting light energy into electrical energy. The electrical energy generated by the solar cells 51 is used, for example, to supply the Peltier elements 71 with electrical energy. This provides, for example, an energy supply for the Peltier elements 71 that is independent of the electrical system of the vehicle.

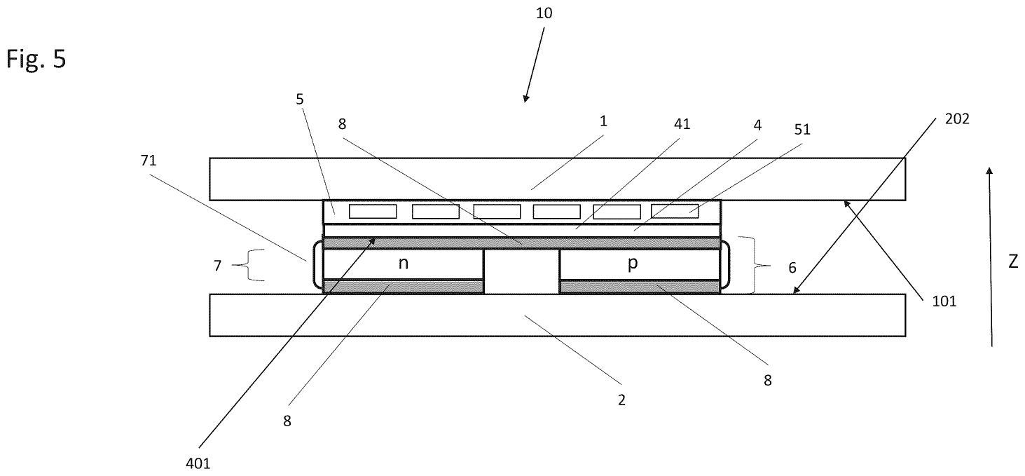

FIG. 5 shows an exemplary embodiment of the arrangement 10 in a schematic sectional view. The exemplary embodiment corresponds substantially to the embodiment according to FIG. 3. In addition, the solar cell layer 5 is coupled to the underside 101 of the outer pane 1, such that the solar cell layer 5 is arranged between the underside 101 of the outer pane 1 and the intermediate layer 4. The cooling device 6 is coupled to an underside 401 of the intermediate layer 4, such that the cooling device 6 is arranged between the intermediate layer 4 and the upper side 202 of the inner pane 2.

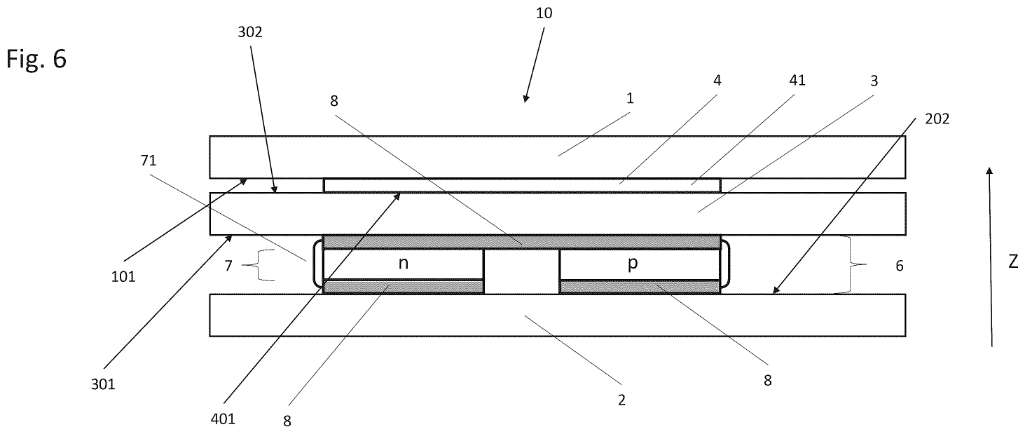

FIG. 6 shows a further exemplary embodiment of the arrangement 10 in a schematic sectional view. In contrast to the exemplary embodiment according to FIGS. 2 to 5, the arrangement 10 has an intermediate pane 3, as a third pane element, which has an upper side 302 and an underside 301. In this case, the intermediate pane 3 is coupled to the inner pane 2, such that the cooling device 6 is arranged between the upper side 202 of the inner pane 2 and the underside 301 of the intermediate pane 3. Also in this case, the intermediate layer 4 is coupled to the underside 101 of the outer pane 1, such that the intermediate layer 4 is arranged between the underside 101 of the outer pane 1 and the upper side 302 of the intermediate pane 3.

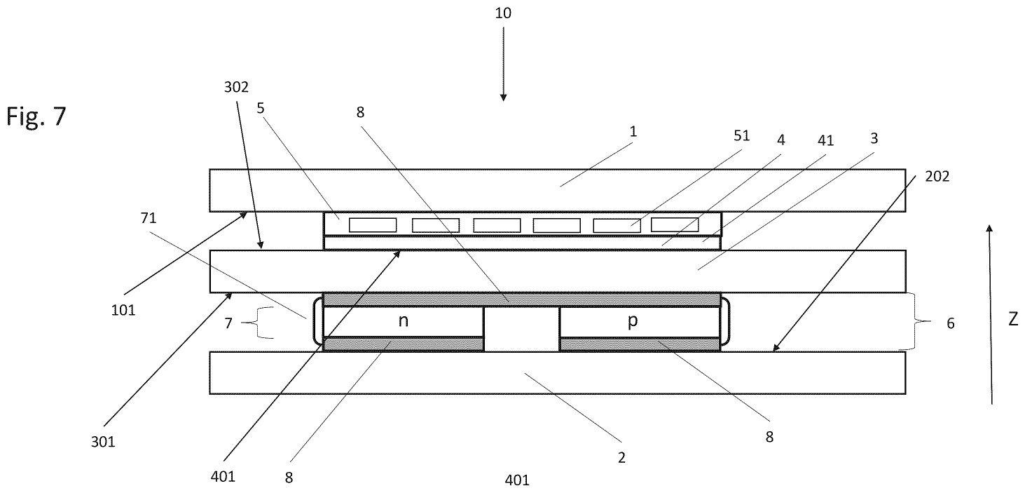

FIG. 7 shows a further exemplary embodiment of the arrangement 10 in a schematic sectional view. Also provided, in addition to the arrangement described in FIG. 6, is the solar cell layer 5, which is coupled to the outer pane 1, such that the solar cell layer 5 is arranged between the underside 101 of the outer pane 1 and the intermediate layer 4.

The solar cell layer 5 is realized, for example, as a transparent solar cell layer. The transparent solar cell layer 5 is realized, for example, as a thin-film solar cell, in that predefined photovoltaic structures have been formed on a carrier glass by means of chemical vapour deposition. The transparent solar cell layer 5 is thus based on thin-film technology. Alternatively or additionally, laser-structured solar cells may be realized with gaps in the solar cell layer 5, such that a certain degree of transparency is achieved. Furthermore, the solar cell layer 5 can also be designed to be so thin that it already affords a certain degree of transparency due to its thinness and can be classified as a transparent solar cell layer 5.

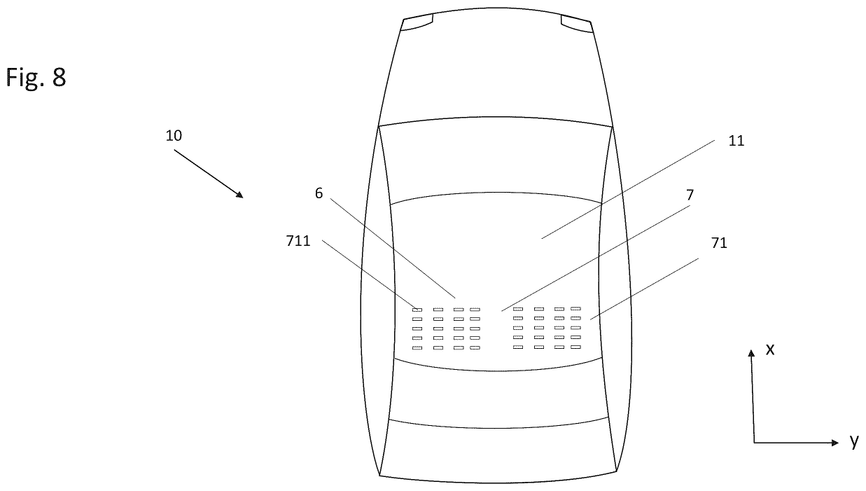

FIG. 8 shows a further exemplary embodiment of the arrangement 10 in a schematic plan view of the vehicle roof 11. The Peltier elements 71 of the cooling device 6 are arranged in the semiconductor layer 7 in the form of individual mutually spaced islands 711. The islands 711 in this case are distributed, for example, on notional straight lines that are substantially parallel and/or orthogonal to the longitudinal axes of the pane elements, in the plane of the pane elements.

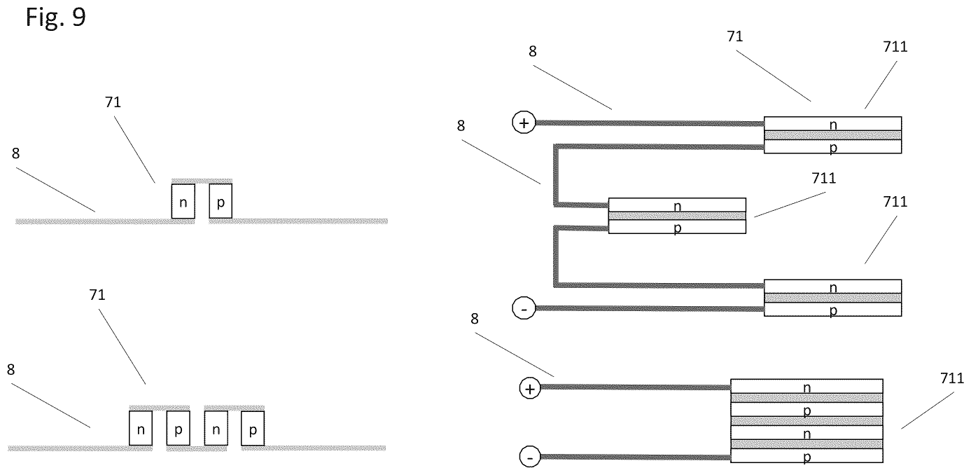

FIG. 9 shows schematic views of an island pattern according to FIG. 8. One island 711 of the islands 711 comprises at least one Peltier element 71. According to further exemplary embodiments, the island 711 additionally has an integrated solar cell 51 located above it (not explicitly represented in FIG. 9). According to exemplary embodiments, islands 711 that which comprise Peltier elements 71 and solar cells 51 may also operate in an autonomously controlled manner, independently of the electrical system of the vehicle. The islands 711 are electrically connected to one another with thin strip conductors 8, as is the case, for example, with conventional window heating systems. In the case of such an island pattern, transparent regions alternate with opaque regions (islands). This provides increased transparency of the vehicle roof 11 while simultaneously cooling the vehicle roof 11 and/or the vehicle interior.

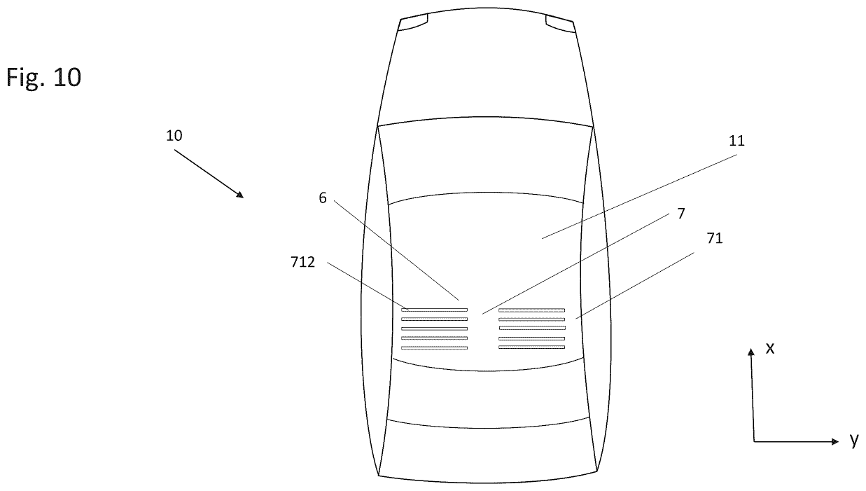

FIG. 10 shows a further exemplary embodiment of the arrangement 10 in a schematic top view of the vehicle roof 11. The Peltier elements 71 of the cooling device 6 are arranged in the semiconductor layer 7 in the form of strips 712. The strips 712 in this case are substantially parallel and/or orthogonal to the longitudinal axes of the pane elements, in the plane of the pane elements. A strip 712 extends continuously over substantially the entire width, or parts of the width, of the vehicle roof 11 (y-direction).

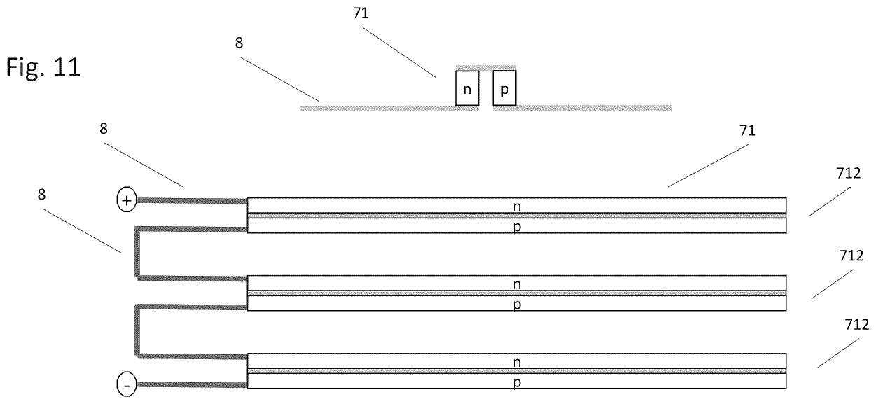

FIG. 11 shows a strip pattern according to FIG. 10 in a schematic view. One of the strips 712 comprises at least one Peltier element 71. According to further exemplary embodiments, the strip 712 additionally has an integrated solar cell 51 located above it (not explicitly represented in FIG. 11). The strip pattern affords a larger cooling surface than the island pattern, and thus a greater effect is achieved in cooling the vehicle roof 11 and/or the vehicle interior.

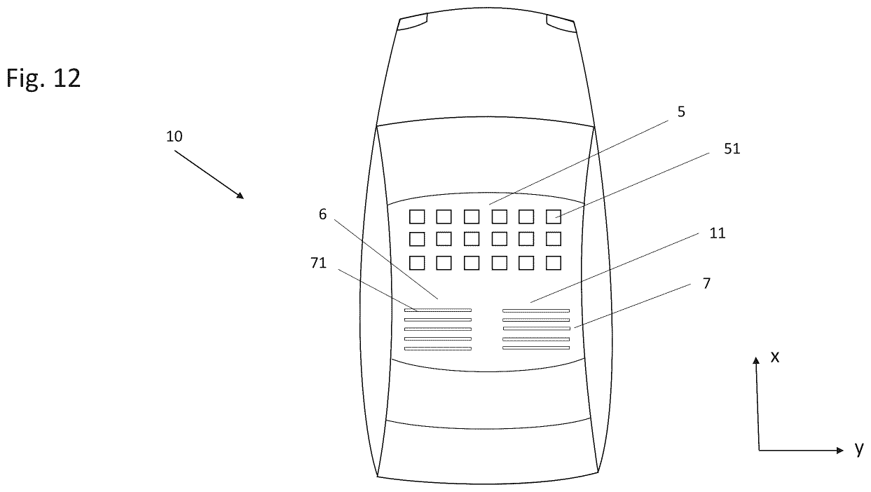

FIG. 12 shows a further exemplary embodiment of the arrangement 10 in a schematic plan view of the vehicle roof 11. The Peltier elements 71 of the cooling device 6 in the semiconductor layer 7 are positioned in a first region of the vehicle roof 11 that does not have the solar cells 51 in the solar cell layer 5. Likewise, the solar cells 51 in the solar cell layer 5 are positioned in a second region of the vehicle roof 11 that does not have the Peltier elements 71 of the cooling device 6 in the semiconductor layer 7.

The two regions are arranged, in particular in succession, along the direction of travel of the vehicle (x-direction). For example, the solar cells 51 are arranged in the front in the direction of travel as in FIG. 12. According to another exemplary embodiment, not explicitly represented, the Peltier elements 71 are arranged at the front in the direction of travel. According to further, not explicitly represented embodiments, the solar cells 51 and Peltier elements 71 are arranged differently, for example next to each other along the x-direction.

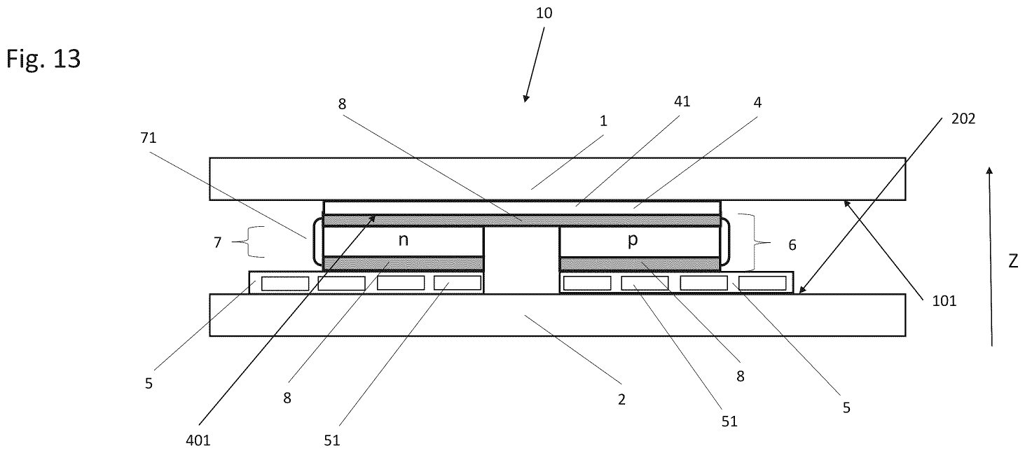

FIG. 13 shows an exemplary embodiment of the arrangement 10 in a schematic sectional view. The exemplary embodiment substantially corresponds to the exemplary embodiment according to FIG. 5. In the exemplary embodiment, the solar cell layer 5 is coupled to the upper side 202 of the inner pane 2, such that the solar cell layer 5 is arranged between the upper side 202 of the inner pane 1 and the cooling device 6. The solar cell layer 5 is divided into two portions, the first portion being arranged partially under the n-doped part of the Peltier element 71. The second section of the solar cell layer 5 is arranged partially under the p-doped part of the Peltier element 71. The solar cells 51 are located between the outer pane 1 and the inner pane 2, beneath the Peltier elements 71, such that heat can be removed from the solar cells 51, which maintains and improves their efficiency. In particular, heat that is directed through the outer pane 1 to the solar cell layer 5 is also prevented from being removed before it reaches and heats the solar cell layer 5. The cooling device 6 is coupled to an underside 401 of the intermediate layer 4, such that the cooling device 6 is arranged between the intermediate layer 4 and the upper side 202 of the inner pane 2.

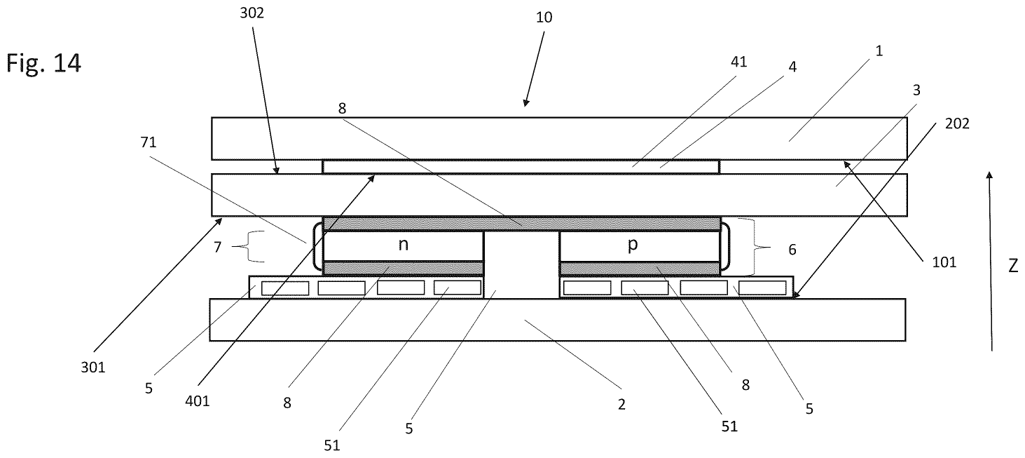

FIG. 14 shows an exemplary embodiment of the arrangement 10 in a schematic sectional view. The exemplary embodiment corresponds substantially to the embodiment according to FIG. 6. In contrast to the exemplary embodiment according to FIGS. 2 to 6, the arrangement 10 has an intermediate pane 3, as a third pane element, which has an upper side 302 and an underside 301. In this case, the intermediate pane 3 is coupled to the inner pane 2, such that the cooling device 6 is arranged between the upper side 202 of the inner pane 2 and the underside 301 of the intermediate pane 3. Also in this case, the intermediate layer 4 is coupled to the underside 101 of the outer pane 1, such that the intermediate layer 4 is arranged between the underside 101 of the outer pane 1 and the upper side 302 of the intermediate pane 3. In addition to the arrangement 10 described in FIG. 6, the solar cell layer 5 is also provided, coupled to the inner pane 2, such that the solar cell layer 5 with the solar cells 51 is arranged between the cooling device 6 and the upper side 202 of the inner pane 2. The solar cell layer 5 is divided into two portions, the first portion being arranged partially under the n-doped part of the Peltier element 71. The second section of the solar cell layer 5 is arranged partially under the p-doped part of the Peltier element 71. The solar cells 51 are located between the outer pane 1 and the inner pane 2, beneath the Peltier elements 71, such that heat can be removed from the solar cells 51, which maintains and improves their efficiency.

Thus, convenient cooling of a vehicle interior and of a vehicle roof 11 is easily realized by means of the arrangement 10. For example, convenient cooling of a vehicle interior and of a vehicle roof 11, in combination with the conversion of light energy into electrical energy as well as a transparent view through the cover 13, is thus easily realized by means of the arrangement 10. The term light energy in this context describes not only radiant energy in the spectral range that is optically visible to humans, but may also include radiant energy in the infrared and/or ultraviolet range and/or other frequency ranges to which the solar cells 51 of the solar cell layer 5 are sensitive.

1. An arrangement for a vehicle roof, comprising:
a first pane element that is configured to realize an outer pane for the vehicle roof,
a second pane element that is configured to realize an inner pane for the vehicle roof, the second pane element being coupled to the first pane element,
a cooling device, which comprises
a semiconductor layer having Peltier elements, and
strip conductors connected to the semiconductor layer, and wherein
the cooling device being designed to cool a vehicle interior, and
being coupled to the second pane element, such that the cooling device is arranged between the first and the second pane element.

2. The arrangement according to claim 1, comprising:
a lamination film, as an intermediate layer, which is coupled to the first pane element, such that the intermediate layer is arranged between the first and the second pane element.

3. The arrangement according to claim 1, comprising:
a solar cell layer that is composed of solar cells, such that the solar cell layer is arranged between the first and the second pane element.

4. The arrangement according to claim 1, wherein the solar cell layer is divided into at least two mutually spaced and separate portions.

5. The arrangement according to a claim 1, comprising:
a third panel element, the third pane element being coupled to the second pane element, such that the semiconductor layer is arranged between the second and the third pane element.

6. The arrangement according to claim 1,
wherein the intermediate layer is made of PVB or PDLC.

7. The arrangement according to claim 1,
wherein the semiconductor layer is applied by means of thin-film technology.

8. The arrangement according to claim 1,
wherein the Peltier elements are realized in the form of individual mutually spaced islands.

9. The arrangement according to claim 8,
wherein the islands that comprise Peltier elements and solar cells operate in an autonomously controlled manner, independently of the electrical system of the vehicle.

10. The arrangement according to claim 1,
wherein the Peltier elements, in the form of strips, are substantially parallel and/or orthogonal to the longitudinal axes of the pane elements, in the plane of the pane elements.

11. The arrangement according to claim 1,
wherein the Peltier elements are positioned in a first region of the vehicle roof that has no solar cells.

12. The arrangement according to claim 3,
wherein the solar cells are positioned in a second region of the vehicle roof that has no Peltier elements.

13. The arrangement according to claim 1,
wherein the cooling device is designed to heat the glass composite for the purpose of de-icing by reversing the current at the Peltier elements.

14. A vehicle roof comprising:
an arrangement according to claim 1,
a roof opening, and
a cover designed to close the roof opening, the cover comprising the arrangement.
